(19) United States
(12) Patent Application Publication
(10) Pub. No.: US 2014/0042682 A1
(43) Pub. Date: Feb. 13, 2014

(54) UNIVERSAL FIXTURE FOR MACHINING A FLAT SUBSTRATE

(71) Applicants: Yixing Bao, Painted Post, NY (US); Yuyin Tang, Dongguan City (CN)

(72) Inventors: Yixing Bao, Painted Post, NY (US); Yuyin Tang, Dongguan City (CN)

(21) Appl. No.: 13/569,341

(22) Filed: Aug. 8, 2012

(51) Int. Cl. B25B 11/00; B23P 17/04

(52) U.S. Cl. 269/21; 29/890.09

(57) ABSTRACT

A fixture apparatus for mounting a flat workpiece to a worktable has at least first and second separately positioned vacuum mount elements, wherein each vacuum mount element has a base having a lower contact surface for seating against the worktable and having a clamping surface spaced apart from the lower contact surface. There is a raised portion that extends orthogonal to the lower contact surface and that has an upper contact surface that is parallel to the lower contact surface for positioning against the flat workpiece, wherein a height dimension between the lower and upper contact surfaces is uniform to within +/−0.02 mm. A vacuum chamber hollowed out within the raised portion is in fluid communication with a vacuum port for providing vacuum force through the vacuum chamber to secure the workpiece against the upper contact surface.

### FIELD OF THE INVENTION

This disclosure generally relates to apparatus and methods for securing a workpiece during tooling and more particularly relates to a system of fixture components configurable for securing flat workpieces of variable dimensions.

### BACKGROUND

Computerized Numerical Control (CNC) and other types of automated machining enable rapid and accurate machining of various types of glass and other flat materials. The quality of the machining process and its repeatability depend, in part, on fixturing the glass sheet or other workpiece so that it is held firmly in place and maintained securely in register throughout the machining process. For this purpose, the conventional practice is to design a fixture that is carefully crafted to the dimensions of the workpiece and that applies sufficient holding force for securing the workpiece as it is processed. Fixture design and fabrication can be a costly process, requiring a considerable amount of time and precision machining, with the dimensions of the target workpiece a factor in overall design and performance. Various types of holding force can be applied, including mechanical clamping force, magnetic holding force, and vacuum. Care must be taken to provide the proper amount of force, without overconstraint, to avoid damaging the workpiece.

Vacuum mount solutions are advantaged for a number of reasons, but often result in complex designs. In order to obtain a suitably uniform holding force over the surface area, vacuum channels, distribution chambers, and venturis are carefully designed and often require intricate routing and sizing. This often means added cost and complexity over fixtures using mechanical or other holding forces. For any type of fixture holding a flat workpiece, the surface of the fixture must be meticulously prepared so that it is flat to within very tight tolerances. Even for a fixture machined in this way, however, it can be difficult to assure that these tolerances are maintained during handling, setup, and machining

The cost, complexity, and time requirements for fixturing present a considerable challenge not only for volume fabrication, but also for prototyping. Rapid turnaround is often a requirement for prototyping and sampling. The ability to meet this requirement and maintain processing quality can be a deciding factor in responding effectively to customer requests and in meeting time-critical goals. Often, fixturing is a bottleneck for the prototyping process.

Thus, it can be appreciated that there is a need for a fixturing solution that meets at least these goals:

(i) configurable for flat glass substrates of various dimensions;

(ii) able to hold and maintain tight tolerances so that the glass or other substrate is maintained in a suitably flat condition during machining;

(iii) able to provide uniform vacuum for substrates of various dimensions;

(iv) can be quickly configured for a particular substrate and dimensions and allows a measure of compensation for correcting for irregularities in the work surface of the CNC or other machine tool; and

(v) maintains workpiece surface quality so that damage to the surface, such as by scratching and abrasion, is minimized.

Conventional fixturing solutions for glass and other flat substrates meet some of these needs, but often fail to meet all of these requirements in a satisfactory manner.

### SUMMARY

It is an object of the present invention to advance the art of fixturing for processing of glass and other flat substrates. With this object in mind, the present disclosure provides a fixture apparatus for mounting a flat workpiece to a worktable, the apparatus comprising:

at least first and second separately positioned vacuum mount elements, wherein each vacuum mount element has:

(i) a base having a lower contact surface for seating against the worktable and having a clamping surface spaced apart from the lower contact surface;

(ii) a raised portion that extends orthogonal to the lower contact surface and that has an upper contact surface that is parallel to the lower contact surface for positioning against the flat workpiece, wherein a height dimension between the lower and upper contact surfaces is uniform to within +/−0.02 mm; and

(iii) a vacuum chamber hollowed out within the raised portion and in fluid communication with a vacuum port for providing vacuum force through the vacuum chamber to secure the workpiece against the upper contact surface.

An advantage provided by the present invention is the capability to adapt to various different workpiece dimensions and still provide uniform clamping force for the workpiece. The workpiece can be held securely, without tilt. Embodiments of the present invention further provide a solution that allows compensation for irregularities in the worktable surface of a CNC or other machine tool. The fixture of the present invention can be set up quickly to meet the requirements of a particular workpiece and can be used with variable levels of vacuum.

Other desirable objectives, features, and advantages of the disclosed invention may occur or become apparent to those skilled in the art. The invention is defined by the appended claims.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A shows a side view of an exemplary fixture apparatus for mounting a glass workpiece to a worktable for machining

FIG. 1B is a corresponding top view to the side view of FIG. 1A

FIG. 1C shows a perspective view of the FIG. 1A arrangement.

FIG. 2 is a top schematic view showing exemplary vacuum connections and routing for the mounting arrangement of FIGS. 1A-1C.

FIG. 3A is a plan view that shows how a vacuum mount element is formed.

FIG. 3B is a perspective view showing the vacuum mount element of FIG. 3A outfitted for vacuum connection and mounting.

FIG. 4 is a top view that shows an exemplary clamping arrangement using the fixture of the present invention.

FIG. 5 is a perspective view that shows an optional alignment guide for fixture positioning.

FIGS. 6A, 6B, and 6C show top views of different configurations using two vacuum mount elements used to hold a smaller workpiece.

FIG. 7A is a side view of the fixture of the present invention used on an irregular worktable surface.

FIG. 7B shows compensation for the irregular worktable surface shown in FIG. 7A.

FIG. 8A is a perspective view of a machined block in an initial fabrication stage for forming a set that has multiple vacuum mount elements.

FIG. 8B is a top view of the machined block of FIG. 8A.

### DETAILED DESCRIPTION

Figures shown and described herein are provided in order to illustrate key principles of operation and fabrication for an apparatus according to various embodiments and a number of these figures are not drawn with intent to show actual size or scale. Some exaggeration may be necessary in order to emphasize basic structural relationships or principles of operation. In a number of the figures given herein, for example, spacing between components is exaggerated for improved visibility and description. The description that follows emphasizes machining applications; however, embodiments of the present invention can be used more generally for any type of processing of a flat workpiece where there is benefit in holding the workpiece securely in position during processing.

In the context of the present disclosure, terms such as “top” and “bottom” or “upper”, “lower”, “above”, and “below” are relative and do not indicate any necessary orientation of a component or surface, but are used simply to refer to and distinguish opposite surfaces or relationships of components. Similarly, terms “horizontal” and “vertical” may be used relative to the figures, to describe the relative orthogonal relationship of components in different planes, for example, but do not indicate any required orientation of components with respect to true horizontal and vertical orientation.

Where they are used, the terms “first”, “second”, “third”, and so on, do not necessarily denote any ordinal or priority relation, but are used for more clearly distinguishing one element or time interval from another. For example, there are no fixed “first” or “second” elements in what is taught herein; these descriptors are merely used to clearly distinguish one element from another similar element in the context of the present disclosure. A “plurality” means two or more. The term “substantially parallel” for planar surfaces means parallel to within +/−0.5 mm or less over the extent of the surface.

According to a broad aspect of the present invention, apparatus and methods are described that provide a configurable fixture apparatus for mounting a workpiece to a worktable for machining Unlike conventional fixture solutions, apparatus of the present invention use a set of multiple vacuum mount elements that are separate from each other and can be independently positioned with appropriate placement for holding glass or other flat workpieces of various dimensions.

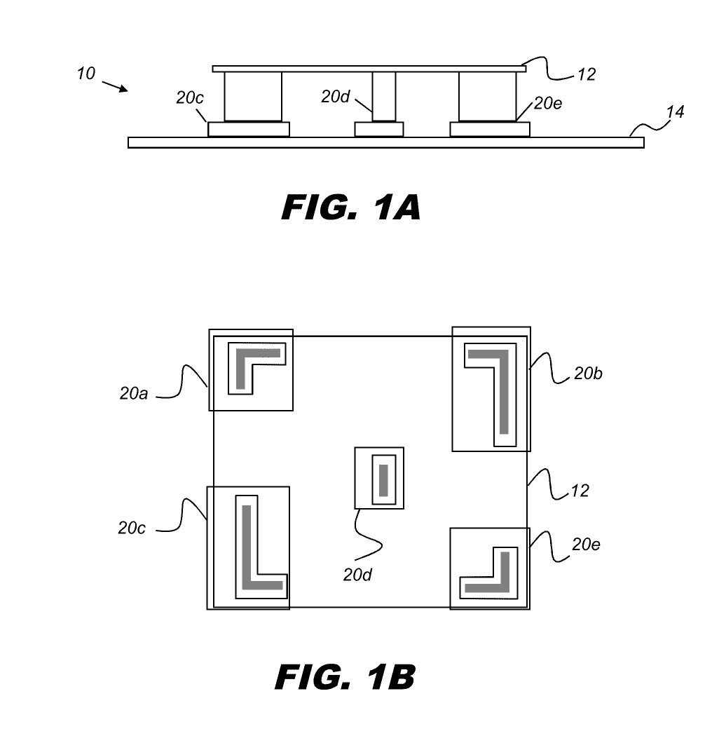

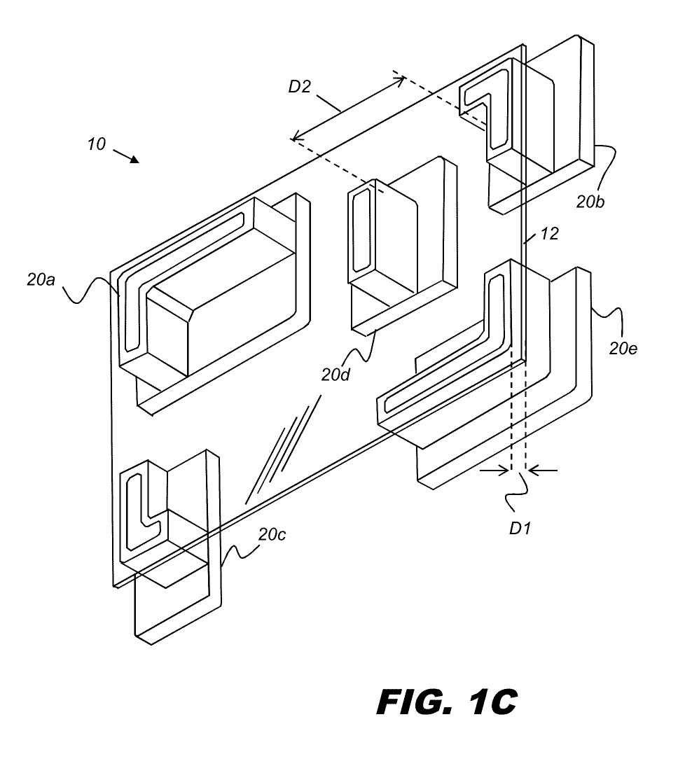

FIG. 1A shows a side view of an exemplary fixture apparatus 10 for mounting a glass workpiece 12 to a worktable 14 for machining or other processing. FIG. 1B is a corresponding top view. Worktable 14 is typically part of a CNC system or other machine tool. A number of vacuum mount elements 20a, 20b, 20c, 20d, and 20e are distributed between worktable 14 and workpiece 12 to support workpiece 12 and clamp it securely in place for machining. FIG. 1C shows a perspective view of an arrangement similar to that of FIGS. 1A and 1B, with five vacuum mount elements 20a, 20b, 20c, 20d, and 20e. Spacing between the mount elements is exaggerated in FIGS. 1A-1C, for improved visibility of individual components.

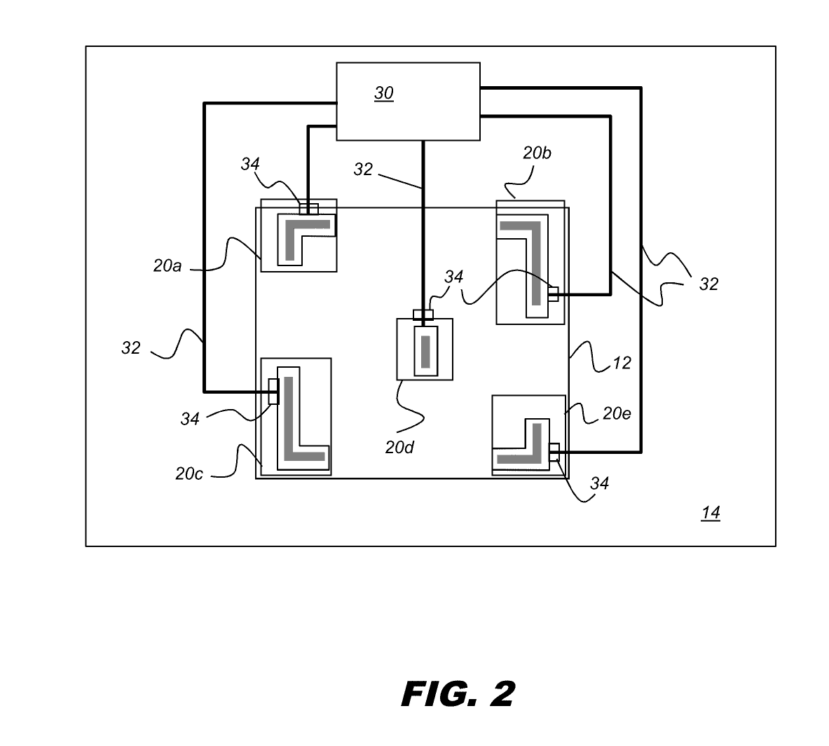

Advantageously, each of the vacuum mount elements 20a, 20b, 20c, 20d, and 20e can be separately positioned, and fewer or more mount elements could be used, depending on factors such as dimensions of workpiece 12 and amount of vacuum provided. Because of this configurability, fixture apparatus 10 allows a considerable measure of flexibility in vacuum mounting for holding a sheet of glass or other workpiece 12. FIG. 2 shows a schematic view of the mounting arrangement of FIGS. 1A-1C, with a vacuum source 30 and individual vacuum hoses 32 that connect through a vacuum port 34 to each of vacuum mount elements 20a, 20b, 20c, 20d, and 20e. Vacuum source 30 may be a vacuum distributor or may simply be vacuum directly provided by the CNC or other machine tool. It can be appreciated that various types of vacuum connectors can be used for connection to vacuum ports 34. One or more of vacuum hoses 32 from the plurality of vacuum mount elements 20a, 20b, 20c, 20d, and 20e may extend through the area that lies between workpiece 12 and worktable 14, as shown in FIG. 2. Vacuum connections can be in series or in parallel.

Vacuum levels can be varied over a wide range, as needed for each particular workpiece 12 in a particular application. According to an example embodiment of the present invention, vacuum in the range between about 500-700 mmHg (negative pressure) is provided for holding the workpiece. It can be appreciated that the vacuum levels that are applied can be varied according to workpiece characteristics and the requirements of the machining process. In addition, according to an embodiment of the present invention, different vacuum levels, such as levels differing from each other by 20% or more, can be applied at different vacuum mount elements 20a, 20b, 20c, 20d, and 20e, depending on the workpiece 12 configuration and on requirements of the machining process.

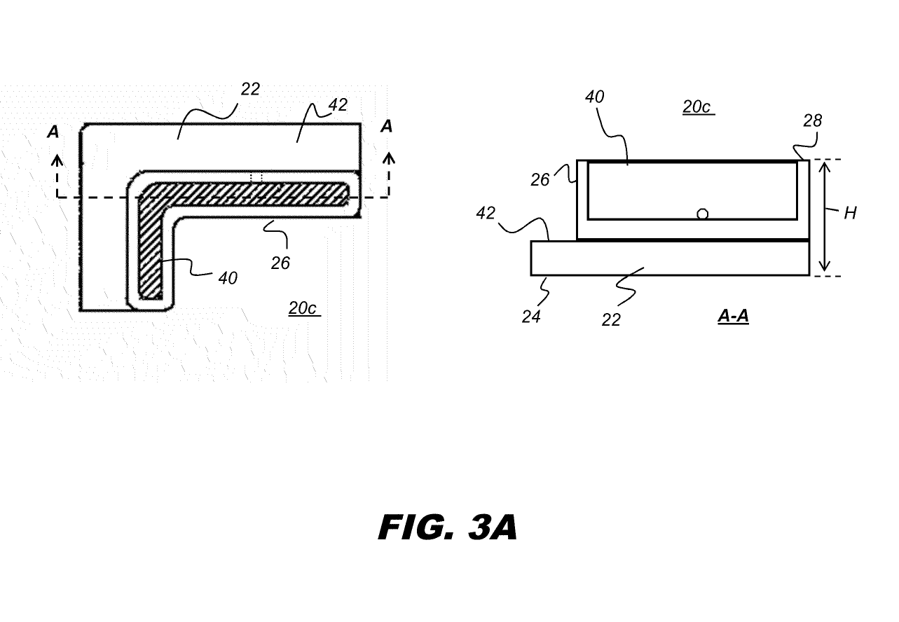

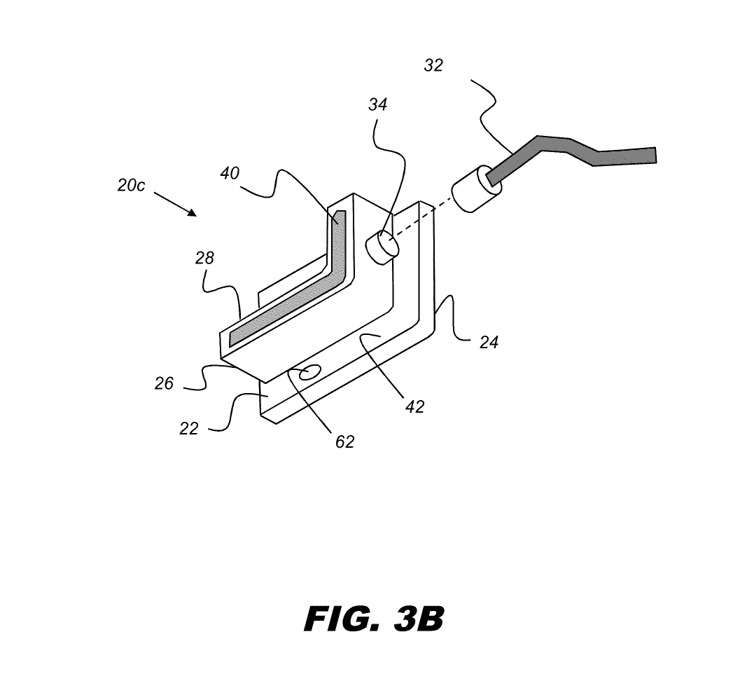

The plan views of FIG. 3A, showing a top view and a sectioned view, and perspective view of FIG. 3B show, by way of example, how vacuum mount element 20c is formed; other vacuum mount elements are formed with similar structures but with different geometries for a raised portion 26 and a base 22. Each vacuum mount element has a base 22 having a worktable contact surface, hereinafter termed a lower contact surface 24. Contact surface 24 seats against the worktable of the machine tool or other suitable surface and is clamped or otherwise held in place against the worktable surface or, alternately, mechanically coupled to one or more other vacuum mount elements that are themselves mounted or clamped to the worktable surface. The vacuum mount element has a raised portion 26 that extends orthogonally from the base, in a direction orthogonal with respect to contact surface 24, and that presents a workpiece contact surface, hereinafter termed an upper contact surface 28 for supporting the workpiece and providing the vacuum force from a vacuum chamber 40 against the workpiece. Upper contact surface 28 is parallel to lower contact surface 24 to within very tight tolerances, preferably the distance between upper and lower contact surfaces 28 and 24, shown as height H, is uniform, machined to within at least +/−0.02 mm or, more preferably, to within +/−0.01 mm or better over the full extent of the upper contact surface 28. This tight tolerance allows the height of each of the vacuum mount elements used in a particular configuration to be uniform, within close tolerance of a predetermined, fixed value. The height H dimension used for vacuum mount elements of a particular fixture apparatus 10 is a predetermined value based on factors such as allowable distance from the worktable, workpiece surface characteristics, and clearance space needed for clamps and vacuum hoses.

Again, it must be emphasized that “upper” and “lower” are relative terms only, used to describe the orientation of contact surfaces 24 and 28 as shown in figures herein. In practice, the lower contact surface seats against the worktable and may thus be vertical or at some other orientation, for example.

As shown in FIGS. 3A and 3B, vacuum chamber 40 is hollowed out within raised portion 26 and is in fluid (vacuum) communication with the source of vacuum through vacuum port 34. Each vacuum mount element has, along its base 22, a clamping surface 42 that is spaced apart from the lower contact surface 24. Clamping surface 42 is substantially parallel to lower contact surface 24 in the embodiment shown. Clamping surface 42 may alternately be configured in a number of different ways for providing features that support clamping or other type of attachment of the vacuum mount element to the worktable surface. One or more holes 62 for threaded fasteners or other type of clamping fastener can optionally be provided, for example. Where the worktable is of suitable material, magnetic force can also be used for clamping or to assist in coarse positioning of mount elements during fixture apparatus setup, such as by forming the vacuum mount element of a magnetized material, such as a ferromagnetic metal. It should be noted that the size and thickness of base 22 and its extension in any direction relative to raised portion 26 can be varied from that shown in the figures given herein, depending on factors such as clamping mechanisms used and range of workpiece dimensions, for example. Thus, for example, the top view of FIG. 3A shows sides of L-shaped raised portion 26 directly along an edge of vacuum mount element 20c. Clamping surface 42 lies only along outer sides of raised portion 26 in this example. Other arrangements of base 22 may be advantageous for particular applications.

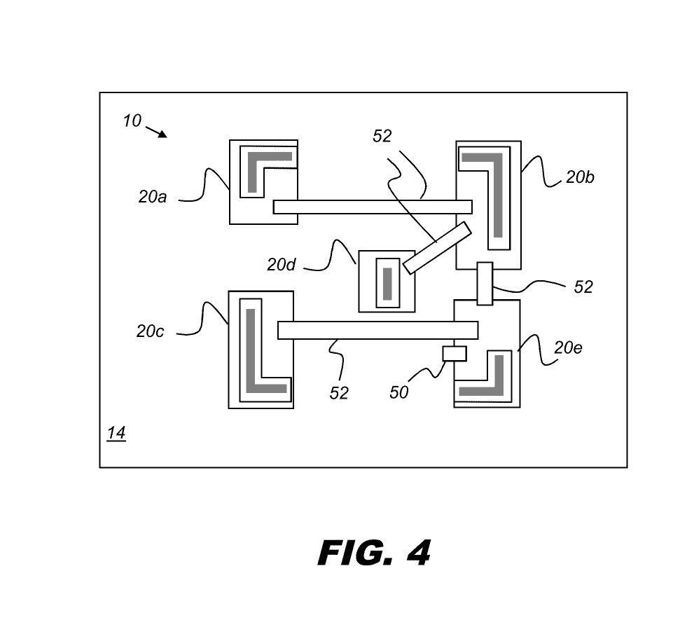

A number of different clamping or mounting arrangements may be used for securing fixture apparatus 10 to the worktable 14 surface. The top view schematic of FIG. 4, with workpiece 12 not shown for clarity, shows one possible configuration in which only one of the vacuum mount elements, vacuum mount element 20e in this example, is directly clamped to the surface of worktable 14. A clamp 50 locks mount element 20e to the worktable 14 surface. Clamp 50 can be any of a number of types of clamping devices, such as a conventional C-clamp, a mounting bolt, and the like. Then, to secure the other mount elements in position, a network of couplings 52 extend from the clamped mount element 20e to each of the other mount elements, or between mount elements. It can be readily appreciated that any number of other arrangements could also be suitable for fixing vacuum mount elements 20a, 20b, 20c, 20d, and 20e in position. Each mount element could be individually clamped or bolted to the worktable 14 surface, for example.

The arrangement shown in FIG. 4 can be advantageous, for example, where it is useful to establish a “benchmark” or reference position relative to the machine tool. With one vacuum mount element fixed in position at a given reference datum, other vacuum mount elements can then be positioned relative to the fixed position. Potential problems of mechanical over-constraint can also be readily addressed with an arrangement of mount elements such as in the example of FIG. 4, with clamping of the reference mount element onto the worktable at a single point location and with coupling of the other mount elements to the clamped mount element.

Because the vacuum mount elements of the present invention can be featured with orthogonal surfaces, as in the examples given herein, alignment of the mount elements to the workpiece 12 and to each other can be straightforward. For example, sides of the L-shaped raised portion 26 are machined to provide a 90 degree angle between them, as shown for vacuum mount element 20c in FIG. 3A. Advantageously, embodiments of the present invention impose no strict rules governing the relative position of each mount element to the workpiece. Setback distance from the edge of the workpiece, shown as overhang distance D1 in FIG. 1C, can be varied and can be larger than the overhang distance that is allowed when using conventional fixed-dimension fixtures. For a typical machined glass, for example, overhang distance is less than about 1-1.75 mm with conventional fixturing; by comparison, embodiments of the present invention allow a maximum overhang distance D1 in the range of about 10 mm. This capability can result in reduced abrasion and overall improved surface quality.

Another advantage offered by embodiments of the present invention relates to flexible separation distance between the mount elements. Of particular interest is the distance between adjacent raised portions 26, shown as a separation distance D2 in FIG. 1C. This distance can be very small, such as for small workpieces as described subsequently. Alternately, for some glass materials, a separation distance of as much as 40-50 mm can be used, depending on factors such as machining techniques used, vacuum levels, and type, dimensions, and thickness of the mounted workpiece, for example. These same factors can also influence how many vacuum mount elements are used in a particular application.

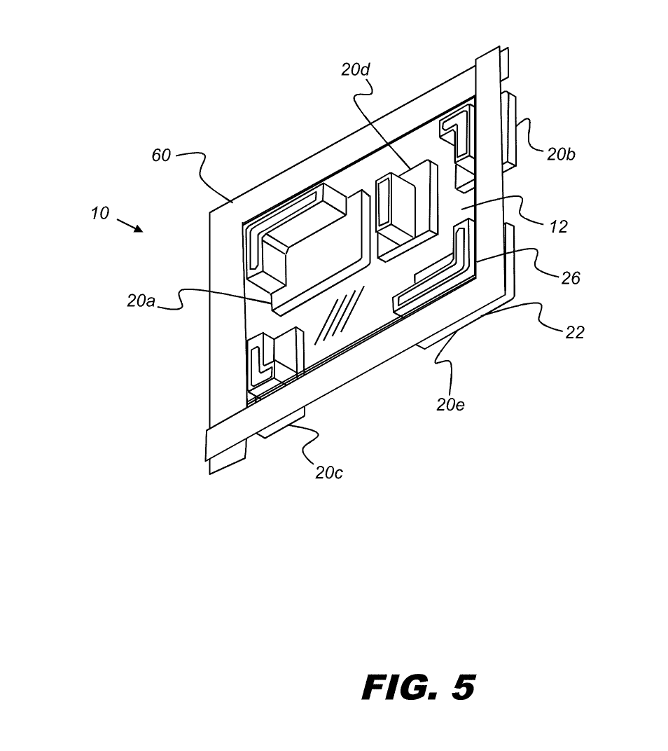

The perspective view of FIG. 5 shows an optional alignment guide 60 that serves to help adjust the position of mount elements relative to the edge of workpiece 12 according to an embodiment of the present invention. Alignment guide 60 fits against the sides of raised portion 26 of one or more mount elements for positioning beneath the workpiece and can adjust for different workpiece dimensions. Alternately, alignment guide 60 can be used against sides or edges of base 22. Optional registration pins and other features (not shown) are provided in alternate embodiments, incorporated into the base for alignment of the workpiece within fixture apparatus 10.

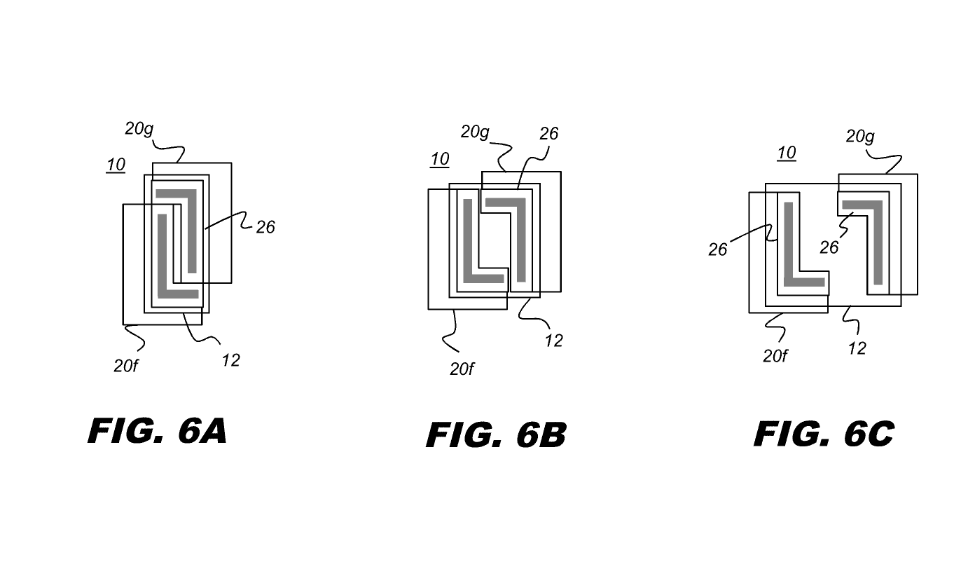

Embodiments of the present invention also allow mounting of relatively small workpieces for machining, such as glass of as small as about 1.5 in.×2.36 in. or larger, for example. FIGS. 6A, 6B, and 6C show top views of different configurations for two vacuum mount elements 20f and 20g used to hold a smaller workpiece 12 sheet. In these embodiments, raised portions 26 of first and second vacuum mount elements 20f and 20g are disposed at diagonal corners of the workpiece 12. Each of vacuum mount elements 20f and 20g has an L-shaped contact surface 28 in the plane of contact against workpiece 12 (FIG. 3A). As shown in this figure and described previously, vacuum mount elements 20f and 20g may be separated from each other by a variable distance or may be in contact against or butted against each other. The mount elements used can have right-angle shape, as shown, or may present some other suitable surface shape to the supported flat workpiece.

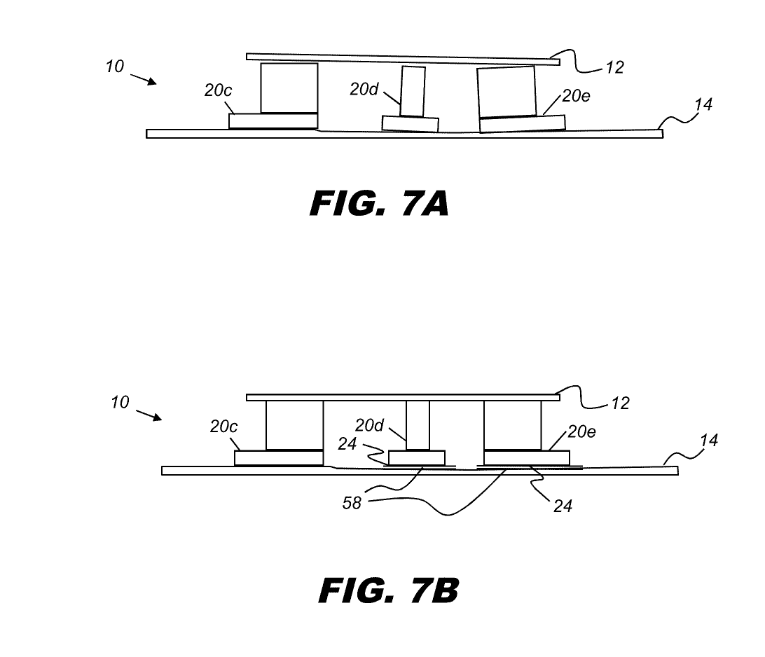

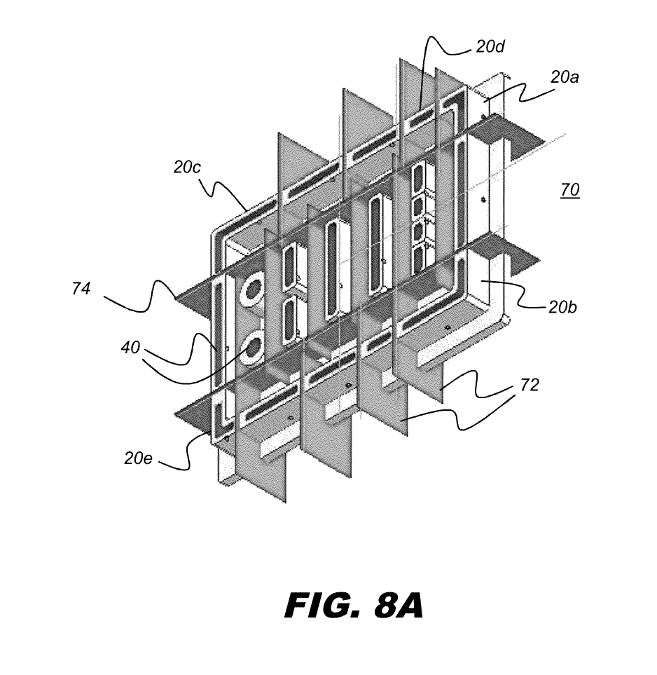

Worktable 14 provided as part of the machining apparatus is ideally flat. In practice, however, worktable 14 may have surface imperfections or may be damaged; embodiments of the present invention allow compensation for problems with worktable 14. FIG. 7A shows, in exaggerated detail for improved clarity, worktable 14 having a defective area, such as a “low spot” that could result in undesirable tilt of workpiece 12. Even a slight amount of tilt or flatness imperfection could cause problems with subsequent machining of workpiece 12. FIG. 7B shows how compensation for this and other defects or irregularities of the worktable 14 surface are provided according to an embodiment of the present invention. One or more adjusting elements 58 are selectively used, inserted between contact surface 24 and worktable 14 to readjust the height of one or more of the vacuum mount elements, 20d and 20e in the example shown. Tape or other suitable material may be used as adjusting element 58.

Fabrication

A feature of embodiments of the present invention is the ability to fabricate multiple, discrete vacuum mount elements that are substantially identical in height H (as shown in FIG. 3A), providing a height H that is uniform to within +/−0.02 mm or better between the contact surfaces 24 and 28, more preferably uniform to within about +/−0.01 mm or better. This level of precision would be difficult to achieve using conventional methods for molding or for machining individual parts. According to an embodiment of the present invention, a number of vacuum mount elements are formed from shaping or machining a single block of metal to form the elements with uniform height, then cutting each individual mount element from the machined block to drill and outfit the element for air connections and optional clamping features. The metal block that is machined can be aluminum, steel, or other suitable material for forming a vacuum component. Where magnetic force is used for clamping, a magnetized material may be machined to form the vacuum mount elements.

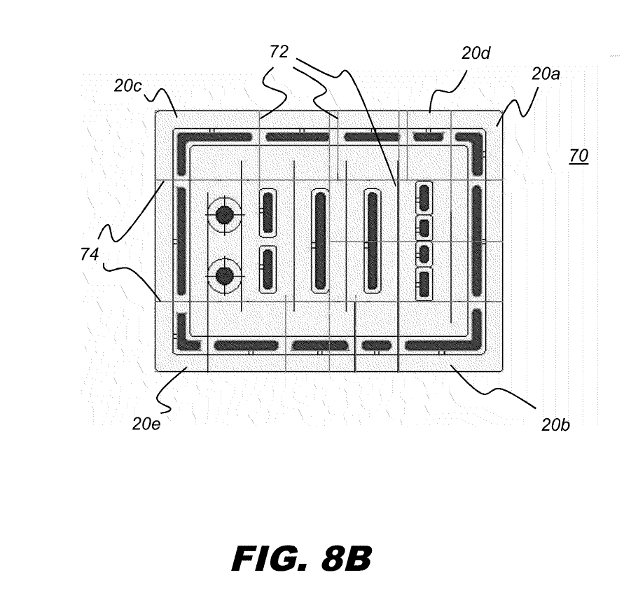

The perspective view of FIG. 8A shows a machined block 70 in an initial fabrication stage for forming a set that has multiple vacuum mount elements. FIG. 8B shows a plan view of this arrangement. A series of orthogonal cutting planes 72 and 74 show at least some of the cuts that are used to separate the individual mount elements from the block once it has been machined. A small number of the vacuum mount elements 20a, 20b, 20c, 20d, and 20e are indicated in these figures. For the particular example shown, a set of twenty-two individual vacuum mount elements are fabricated from a single machined block 70. As shown, the raised portion 26 of the vacuum mount elements made from a single block of metal can be varied in shape, such as circular, having a right angle or L-shaped, or generally linear or rectangular such as rounded rectangular, for example, to provide a corresponding surface to the supported workpiece. It should be noted that the order in which cuts are made along cutting planes 72 and 74 can be optimized for improved quality and efficiency, using approaches and techniques known to those skilled in the tool fabrication arts. Wire cutting or other suitable cutting method can be used for separating the individual vacuum mount elements from the machined block of material, according to an embodiment of the present invention.

An exemplary series of fabrication steps used for generating a set of vacuum mount elements formed from the same block of metal is as follows:

(i) Machine the raised portions 26 for the set of vacuum mount elements.

(ii) Machine the hollowed out vacuum chamber 40 that is within each raised portion 26.

(iii) Process the base of the vacuum mount elements for mounting against the CNC or other worktable.

(iv) Drill air connection holes and threads for air connectors where accessible in machined block 70 (that is, initially for vacuum mount elements along the periphery of the block).

(v) Grind the top surface of machined block 70 to obtain highly uniform heights for each of the vacuum mount elements.

(vi) Make successive separation cuts, such as along cutting planes 72 and 74, to separate the mount elements from each other.

(vii) Complete the air connection drilling for mount elements further within the block.

(viii) Affix air connectors, such as quick-connect air connectors, to each element for ease of configuration.

(ix) Perform final preparation and corrosion resistance treatments.

Steps (iv), (vii) and (viii) outfit each of the respective separated vacuum mount elements with a vacuum port that is in fluid communication with the corresponding vacuum chamber, allowing vacuum connection to source 30 (FIG. 2). The vacuum force, applied as air is drawn or suctioned through vacuum chamber 40 (FIGS. 3A, 3B), securely grips the surface of the workpiece.

Embodiments of the present invention provide a fixture solution that is highly configurable for flat glass substrates of various dimensions and that is able to hold and maintain tight tolerances so that the glass or other substrate is maintained in a suitably flat condition during machining It can be appreciated that tight tolerances of within better than +/−0.02 mm or even +/−0.01 mm per part also allow separate vacuum mount elements to be closely matched with each other. Individual vacuum mount elements can be distributed as needed to secure a flat workpiece in position for machining or other processing to provide uniform vacuum for glass and other substrates of various dimensions. The fixture of the present invention can be quickly assembled for a particular type of material having a range of possible dimensions and allows a measure of compensation for correcting for irregularities in the work surface of the CNC or other machine tool. Variable vacuum levels can be used. Any of a number of suitable surface treatments can be provided for contact surfaces 24 and 28. Alternately, the workpiece itself can be treated for improved contact against contact surface 28, such as using tape or other material.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The configuration and relative dimensions of the base and related clamping surfaces for a vacuum mount element, for example, can vary widely from that shown herein. The mount elements of the present invention can be used with a worktable that is horizontally or vertically positioned, for example. The invention is defined by the claims.

Thus, what is provided is an apparatus and method for a system of fixture components configurable for securing flat workpieces of variable dimensions.

1. A fixture apparatus for mounting a flat workpiece to a worktable, the apparatus comprising:
at least first and second separately positioned vacuum mount elements, wherein each vacuum mount element has:
(i) a base having a lower contact surface for seating against the worktable and having a clamping surface spaced apart from the lower contact surface;
(ii) a raised portion that extends orthogonal to the lower contact surface and that has an upper contact surface that is parallel to the lower contact surface for positioning against the flat workpiece, wherein a height dimension between the lower and upper contact surfaces is uniform to within +/−0.02 mm; and
(iii) a vacuum chamber hollowed out within the raised portion and in fluid communication with a vacuum port for providing vacuum force through the vacuum chamber to secure the workpiece against the upper contact surface.

2. The fixture apparatus of claim 1 wherein the upper contact surface is circular, linear, rectangular, or right-angle shaped.

3. The fixture apparatus of claim 1 wherein the clamping surface is substantially parallel to the lower contact surface.

4. The fixture apparatus of claim 1 wherein each of the at least first and second vacuum mount elements is clamped to the worktable.

5. The fixture apparatus of claim 1 wherein the clamping surface of one or more of the mount elements is clamped to the worktable and one or more of the mount elements are mechanically coupled to each other.

6. The fixture apparatus of claim 1 further comprising an alignment tool that fits against an edge of one or more of the at least first and second mount elements for positioning beneath the workpiece.

7. The fixture apparatus of claim 1 wherein the flat workpiece is glass.

8. The fixture apparatus of claim 1 wherein the worktable is part of a computerized numerical control machine.

9. The fixture apparatus of claim 1 wherein each of the at least first and second vacuum mount elements connects to a vacuum distributor.

10. The fixture apparatus of claim 1 wherein the bases of the at least first and second vacuum mount elements are in contact against each other.

11. The fixture apparatus of claim 1 wherein one or more vacuum hoses from the at least first and second vacuum mount elements extends between the workpiece and the worktable.

12. The fixture apparatus of claim 1 wherein the base has at least one hole for a clamping fastener.

13. A fixture apparatus for mounting a flat workpiece to a worktable for machining, the apparatus comprising:
at least first and second separately positioned vacuum mount elements, wherein each of the vacuum mount elements has:
(i) a flat base having a lower contact surface for seating against the worktable and having a clamping surface spaced apart from and substantially parallel to the lower contact surface;
(ii) a raised portion that extends orthogonal to the base and that has an upper contact surface that is parallel to the lower contact surface for positioning against the flat workpiece and wherein the upper contact surface is L-shaped; and
(iii) a vacuum chamber hollowed out within the raised portion and in fluid communication with a vacuum port for providing vacuum force through the vacuum chamber to secure the workpiece;
and
wherein a height distance between the lower and upper contact surfaces for each mount element of the fixture is uniform to within +/−0.02 mm.

14. The fixture apparatus of claim 13 wherein one or more vacuum hoses from the at least first and second vacuum mount elements extend between the workpiece and the worktable.

15. A method for mounting a flat workpiece to a worktable, the method comprising:
a) shaping a metal block to form a plurality of vacuum mount elements, wherein the metal block has a base and a top surface, and wherein each vacuum mount element has
(i) a flat base having a lower contact surface along the base of the metal block for seating against the worktable and having a clamping surface spaced apart from and parallel to the lower contact surface;
(ii) a raised portion that extends orthogonal to the base and that has an upper contact surface along the top surface of the metal block for positioning against the flat workpiece;
(iii) a vacuum chamber hollowed out within the raised portion;
b) machining the top and bottom surfaces of the metal block to provide a uniform distance between upper and lower contact surfaces to within no more than +/−0.02 mm;
c) cutting the machined metal block to separate each of the plurality of the vacuum mount elements from each other; and
d) outfitting each of the separated vacuum mount elements with a vacuum port that is in fluid communication with the corresponding vacuum chamber.

16. The method of claim 15 further comprising:
e) mounting the outfitted vacuum mount elements at positions along the worktable for securing the workpiece; and
f) applying a vacuum for holding the flat workpiece against the upper contact surfaces of the outfitted vacuum mount elements.

17. The method of claim 15 wherein the metal block is aluminum or steel.

18. The method of claim 15 further wherein mounting the outfitted vacuum mount elements comprises using an alignment tool.

19. The method of claim 16 wherein mounting the outfitted vacuum mount elements comprises clamping a first mount element to the worktable and coupling at least a second mount element to the first mount element.

20. The method of claim 16 wherein applying a vacuum comprises applying a first vacuum level to a first vacuum mount element and a second vacuum level to a second vacuum mount element and wherein the first and second vacuum levels differ from each other by more than about 20%.
